(19) United States
(12) Patent Application Publication
(10) Pub. No.: US 2025/0260243 A1
(43) Pub. Date: Aug. 14, 2025

(54) POWER SUPPLY DEVICE AND ELECTRIFIED VEHICLE INCLUDING THE SAME

(71) Applicant: TOYOTA JIDOSHA KABUSHIKI KAISHA, Toyota-shi (JP)

(72) Inventors: Takashi KATAYAMA, Toyota-shi (JP); Kotaro ASABA, Toyota-shi (JP)

(73) Assignee: TOYOTA JIDOSHA KABUSHIKI KAISHA, Toyota-shi (JP)

(21) Appl. No.: 18/941,089

(22) Filed: Nov. 8, 2024

(30) Foreign Application Priority Data
Feb. 8, 2024 (JP) 2024-017886

(51) Int. Cl. H02J 7/00; B60L 53/16

(52) U.S. Cl. CPC H02J 7/0024; B60L 53/16; H02J 7/0019; H02J 7/0048; H02J 7/0063

(57) ABSTRACT

The power supply device includes a connection circuit that selectively forms a plurality of battery units, a series circuit that connects the plurality of battery units in series to an electrical load, and a parallel circuit that connects the plurality of battery units in parallel to the electrical load, and a control device that controls an operation of the connection circuit. The controller is capable of individually connecting and disconnecting each of the plurality of battery units to an electrical load in a parallel circuit. The control device is configured to control the connection circuit to form a parallel circuit when regenerative power is supplied from the electrical load to the plurality of battery units.

### CROSS-REFERENCE TO RELATED APPLICATION

This application claims priority to Japanese Patent Application No. 2024-017886 filed on Feb. 8, 2024, incorporated herein by reference in its entirety.

### BACKGROUND

### 1. Technical Field

The technique disclosed herein relates to a power supply device and an electrified vehicle including the power supply device.

### 2. Description of Related Art

Japanese Unexamined Patent Application Publication No. 2020-099142 (JP 2020-099142 A) discloses a power supply device. The power supply device includes a plurality of battery units, a connection circuit, and a control device that controls an operation of the connection circuit. The connection circuit selectively forms a series circuit that connects a plurality of battery units in series to an electrical load or a parallel circuit that connects the battery units in parallel to the electrical load. When regenerative power is supplied from the electrical load to the battery units, the control device controls the connection circuit to directly form a circuit.

### SUMMARY

In the power supply device as disclosed in JP 2020-099142 A, a remaining capacity difference is generated among the battery units due to variations in manufacture and variations in deterioration. In the case where the regenerative power is supplied to the battery units, when the battery units are connected in series, an increase in the remaining capacity difference among the battery units is suppressed. However, it is not possible to reduce the remaining capacity difference among the battery units.

In this specification, there is provided a technique capable of reducing a remaining capacity difference among a plurality of battery units.

In a first aspect disclosed herein, a power supply device may include:
a plurality of battery units;
a connection circuit that selectively forms a series circuit that connects the battery units in series to an electrical load or a parallel circuit that connects the battery units in parallel to the electrical load; and
a control device that controls an operation of the connection circuit.

The control device may be able to individually connect and disconnect each of the battery units to and from the electrical load in the parallel circuit.

The control device may be configured to control the connection circuit to form the parallel circuit when the regenerative power is supplied from the electrical load to the battery units.

In the above configuration, the power can be supplied to the electrical load by discharging the battery units. In addition, the battery units can be charged by the regenerative power from the electrical load. At this time, when the battery units are connected in series, all the battery units are charged equally. That is, charging of all the battery units is started at the same time, and the charging of all the battery units is completed at the same time. Therefore, even if a remaining capacity difference is generated among the battery units, the remaining capacity difference is not eliminated or reduced. On the other hand, when the battery units are connected in parallel, it becomes possible to individually connect and disconnect each of the battery units to and from the electrical load. This makes it possible to charge the battery unit with a low remaining capacity while prohibiting charging of the battery unit with a high remaining capacity when the regenerative power is supplied from the electrical load. This makes it possible to reduce the remaining capacity difference among the battery units.

In a second aspect, in the first aspect, when controlling the connection circuit to form the parallel circuit, the control device may connect, to the electrical load, the battery units preferentially from the battery unit with the lowest remaining capacity.

According to the above configuration, the regenerative power supplied from the electrical load is preferentially supplied to the battery unit with the lowest remaining capacity. Therefore, the remaining capacity difference among the battery units can be reduced at an early stage.

In a third aspect, in the first or second aspect, when supplying the power from the battery units to the electrical load, the control device may control the connection circuit to form the series circuit.

According to the above configuration, it is possible to supply higher-voltage power to the electrical load from the battery units as compared with a configuration in which the parallel circuit is formed by the connection circuit.

In a fourth aspect, in any one of the first to third aspects, in a state in which the connection circuit forms the parallel circuit, the connection circuit may be provided with a circulating current suppressing mechanism that suppresses a circulating current from flowing among the battery units.

When the circulating current flows among the battery units, an abnormality may occur in the connection circuit. According to the above configuration, it is possible to suppress occurrence of abnormality in the connection circuit.

In a fifth aspect, an electrified vehicle may include:
the power supply device according to any one of the first to fourth aspects; an electric motor that drives wheels of the electrified vehicle as the electric load; and a charging port that is configured such that an external charging device is attachable to and detachable from the charging port, and is connected to the battery units via the connection circuit.

In the electrified vehicle, discharging and charging of the battery units are repeated highly frequently in accordance with acceleration and deceleration of the electrified vehicle. Therefore, adopting the power supply device according to the present technique in the electrified vehicle enables the remaining capacity difference among the battery units to be eliminated highly frequently while the electrified vehicle is traveling normally. This makes it possible to eliminate or reduce the remaining capacity difference among the battery units in advance before the battery units are charged by an external charging device. Therefore, it is possible to easily charge the battery units to a fully charged state without requiring complicated control when charging with the external charging device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic of an electrified vehicle 2;

FIG. 2 shows a circuit diagram of a first series circuit formed by the connection circuit 22;

FIG. 3 shows a circuit diagram of a first parallel circuit formed by the connection circuit 22;

FIG. 4 shows a circuit diagram of a first regeneration circuit formed by the connection circuit 22;

FIG. 5 shows a circuit diagram of a second regeneration circuit formed by the connection circuit 22;

FIG. 6 shows a circuit diagram of a second series circuit formed by the connection circuit 22;

FIG. 7 shows a circuit diagram of a second parallel circuit formed by connection circuit 22; and

FIG. 8 is a flowchart of a switching process executed by the control device 24.

### DETAILED DESCRIPTION OF EMBODIMENTS

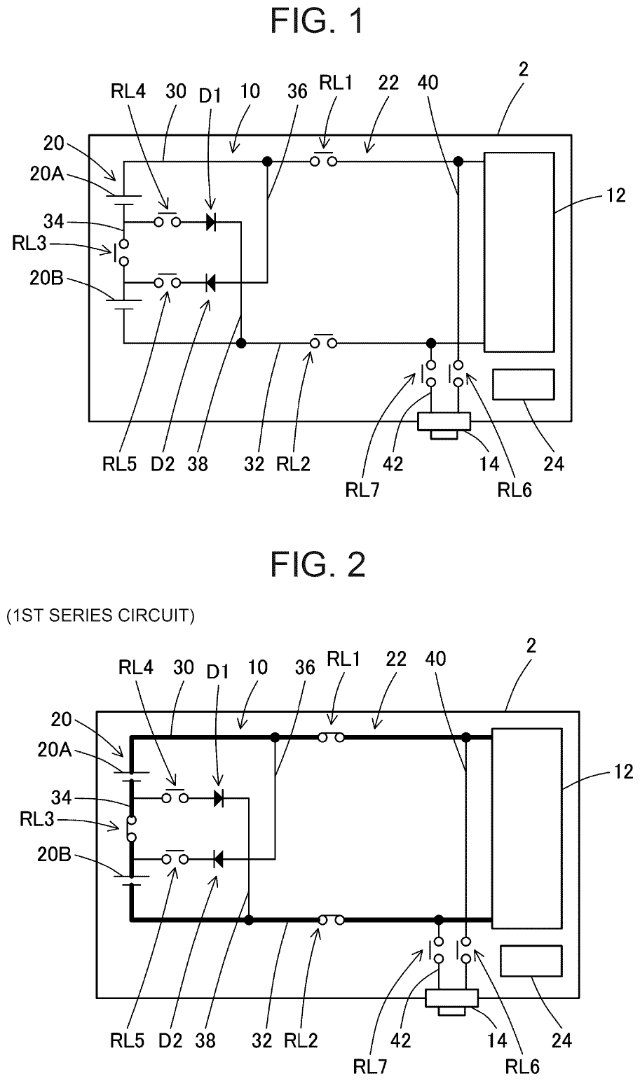

Referring to FIGS. 1 to 7, electrified vehicle 2 will be described. Electrified vehicle 2 is battery electric vehicle, hybrid electric vehicle, plug-in hybrid electric vehicle, fuel cell electric vehicle or the like.

As illustrated in FIG. 1, electrified vehicle 2 includes a power supply device 10, an electric motor 12, and a charging port 14. A charging plug of an external charging device is detachably connected to the charging port 14.

The power supply device 10 includes a plurality of battery units 20, a connection circuit 22, and a control device 24. The plurality of battery units 20 includes a first battery unit 20A and a second battery unit 20B. The rated voltages of the first battery unit 20A and the second battery unit 20B are 400V. The electric motor 12 functions as an electric motor that drives the wheels of electrified vehicle 2 by using electric power supplied from the plurality of battery units 20, and also functions as a generator that generates electric power from a regenerative braking force or the like.

The connection circuit 22 includes a positive electrode power supply line 30, a negative electrode power supply line 32, a series line 34, a first parallel line 36, and a second parallel line 38. The positive electrode power supply line 30 electrically connects the positive electrode of the first battery unit 20A and the electric motor 12. The positive electrode power supply line 30 is provided with a first relay RL1. The negative electrode power supply line 32 electrically connects the negative electrode of the second battery unit 20B and the electric motor 12. A second relay RL2 is provided in the negative electrode power supply line 32. The series-line 34 electrically connects the positive electrode of the second battery unit 20B and the negative electrode of the first battery unit 20A. A third relay RL3 is provided in the series line 34. The first parallel line 36 electrically connects a section between the first battery unit 20A and the first relay RL1 of the positive electrode power supply line 30 and a section between the second battery unit 20B and the third relay RL3 of the series line 34. A fourth relay RL4 and a first diode D1 are provided in the first parallel line 36. The first diode D1 allows current to flow from the positive electrode power supply line 30 toward the series line 34 and prohibits current from flowing from the series line 34 toward the positive electrode power supply line 30. The second parallel line 38 electrically connects a section between the second battery unit 20B and the second relay RL2 of the negative electrode power supply line 32 and a section between the first battery unit 20A and the third relay RL3 of the series line 34. A fifth relay RL5 and a second diode D2 are provided in the second parallel line 38. The second diode D2 allows current to flow from the series line 34 toward the negative electrode power supply line 32 and prohibits current from flowing from the negative electrode power supply line 32 toward the series line 34.

The connection circuit 22 further includes a positive electrode charging line 40 and a negative electrode charging line 42. The positive electrode charging line 40 electrically connects the section between the first relay RL1 of the positive electrode power supply line 30 and the electric motor 12 and the charging port 14. A sixth relay RL6 is provided in the positive electrode charging line 40. The negative electrode charging line 42 electrically connects the section between the second relay RL2 of the negative electrode power supply line 32 and the electric motor 12 and the charging port 14. A seventh relay RL7 is provided in the negative electrode charging line 42.

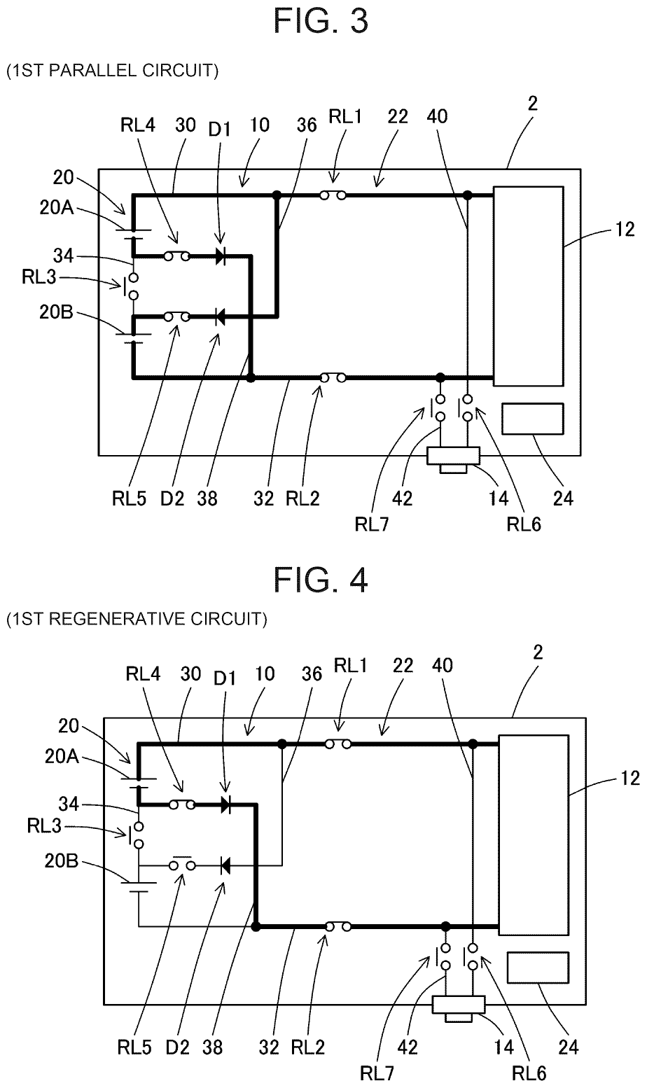

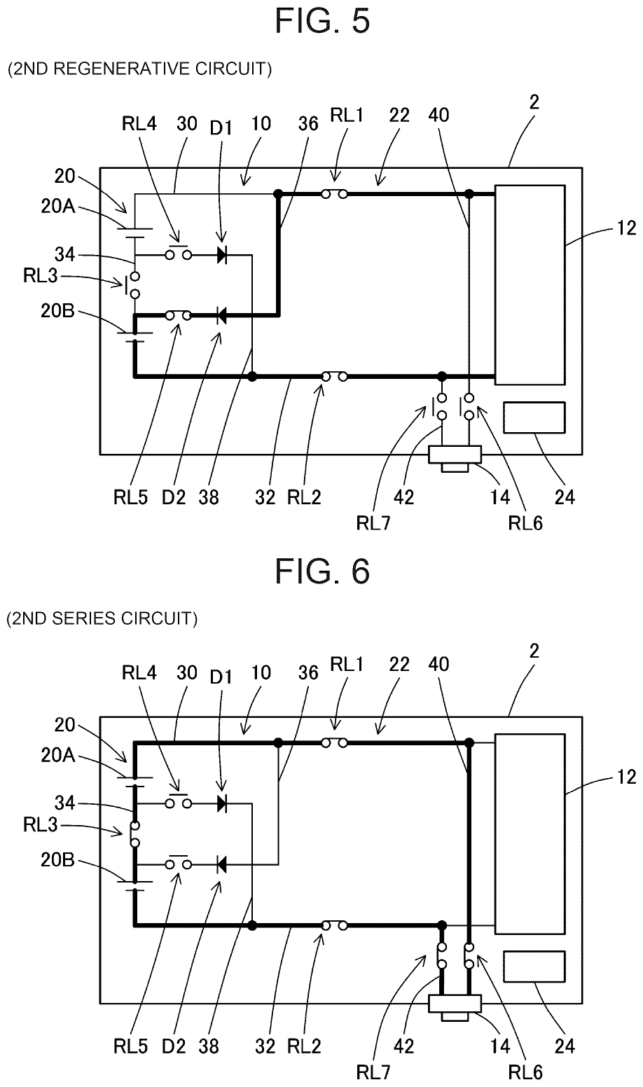

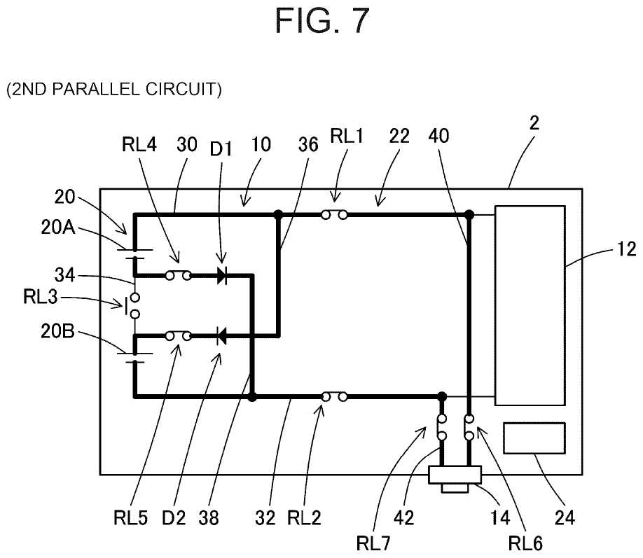

The control device 24 is a computer including a CPU. The control device 24 controls the operation of the seventh relay RL7 from the first relay RL1. The control device 24 controls the operation of the seventh relay RL7 from the first relay RL1, the first series circuit (see FIG. 2), the first parallel circuit (see FIG. 3), the first regenerative circuit (see FIG. 4), the second regenerative circuit (see FIG. 5), the second series circuit (see FIG. 6), and the second parallel circuit (see FIG. 7) can be formed in the connection circuit 22. In the first series circuit, a plurality of battery units 20 are connected in series to the electric motor 12. In the first parallel circuit, a plurality of battery units 20 are connected in parallel to the electric motor 12. In the first regenerative circuit, the first battery unit 20A is connected to the electric motor 12. In the second regenerative circuit, the second battery unit 20B is connected to the electric motor 12. In the second series circuit, a plurality of battery units 20 are connected in series to the charging port 14. In the second parallel circuit, a plurality of battery units 20 are connected in parallel to the charging port 14.

Referring to FIGS. 2 to 7, a first series circuit, a first parallel circuit, a first regenerative circuit, a second regenerative circuit, a second series circuit, and a second parallel circuit formed by the connection circuit 22 will be described. In FIG. 2 to FIG. 7, a path through which a current flows is indicated by a thick line for ease of understanding.

As shown in FIG. 2, the first series circuit is formed by closing the third relay RL3 from the first relay RL1 and opening the seventh relay RL7 from the fourth relay RL4. The control device 24 controls the connection circuit 22 to form a first series circuit when the electric motor 12 is operating as a motor functioning as an electric motor. As an example, the case where the motor is operating is a case where the accelerator pedal of electrified vehicle 2 is operated by the user.

As shown in FIG. 3, the first parallel circuit is formed by closing the first relay RL1, the second relay RL2, the fourth relay RL4, and the fifth relay RL5 and opening the third relay RL3, the sixth relay RL6, and the seventh relay RL7. The control device 24 controls the connection circuit 22 to form a first parallel circuit when the electric motor 12 is in a regenerative operation functioning as a prime mover. As an example, the case where the regenerative operation is being performed is a case where the accelerator pedal of electrified vehicle 2 is not operated by the user and a case where the brake pedal is operated.

As shown in FIG. 4, the first regenerative circuitry is formed by closing the first relay RL1, the second relay RL2, and the fourth relay RL4 and opening the seventh relay RL7 from the third relay RL3 and the fifth relay RL5. At a timing of switching from the motor operation to the regeneration operation, the remaining capacity of the first battery unit 20A (hereinafter, referred to as “first remaining battery capacity”) may be smaller than the remaining capacity of the second battery unit 20B (hereinafter, referred to as “second remaining battery capacity”). In this case, the control device 24 controls the connection circuit 22 to form the first regenerative circuit.

As shown in FIG. 5, the first relay RL1, the second relay RL2, and the fifth relay RL5 are closed, and the third relay RL3, the fourth relay RL4, the sixth relay RL6, and the seventh relay RL7 are opened to form the second regenerative circuitry. The control device 24 controls the connection circuit 22 to form a second regenerative circuit when the second remaining battery capacity is smaller than the first remaining battery capacity at a timing of switching from the motor operation to the regenerative operation.

As shown in FIG. 6, the third relay RL3, the sixth relay RL6, and the seventh relay RL7 are closed from the first relay RL1, and the fourth relay RL4 and the fifth relay RL5 are opened to form the second series circuitry. When 800V charging power is supplied from an external charging device, the control device 24 controls the connection circuit 22 to form a second series circuit.

As shown in FIG. 7, the seventh relay RL7 is closed from the first relay RL1, the second relay RL2, and the fourth relay RL4, and the third relay RL3 is opened to form the second parallel circuit. When 400V charging power is supplied from an external charging device, the control device 24 controls the connection circuit 22 to form a second series circuit.

In a state in which the first series circuit, the second series circuit, or the second parallel circuit is formed, the remaining capacity of one of the plurality of battery units 20 may be a full charge capacity. In this case, the control device 24 is configured to stop the supply of electric power to the plurality of battery units 20.

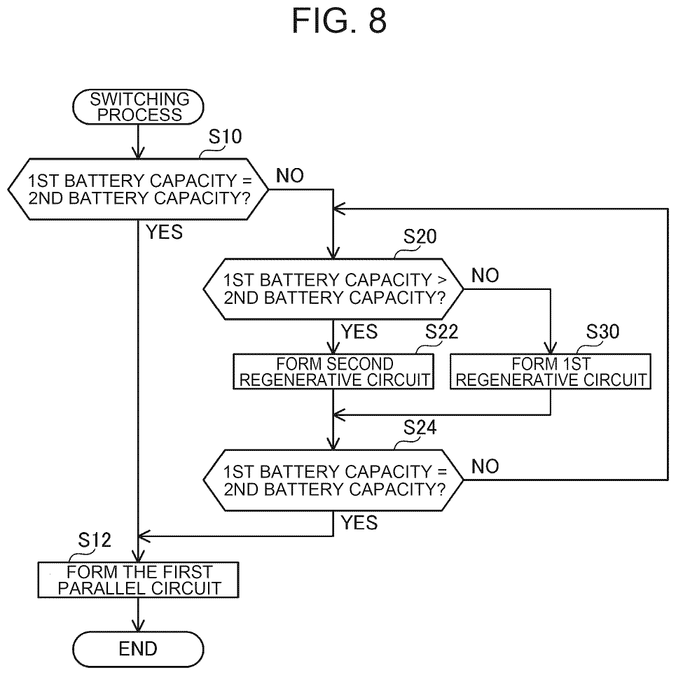

With reference to FIG. 8, a switching process executed by the control device 24 when switching from the motor operation to the regenerative operation will be described.

In S10, the control device 24 determines whether or not the first remaining battery capacity and the second remaining battery capacity are the same. When the first remaining battery capacity and the second remaining battery capacity are the same (YES in S10), the control device 24 proceeds to S12. Note that the first remaining battery capacity and the second remaining battery capacity being the same include not only a case where the first remaining battery capacity and the second remaining battery capacity completely coincide with each other, but also a case where the first remaining battery capacity and the second remaining battery capacity are slightly different from each other. On the other hand, when the first remaining battery capacity and the second remaining battery capacity are not the same (NO in S10), the control device 24 proceeds to S20.

In S12, the control device 24 controls the connection circuit 22 to form a first parallel circuit (see FIG. 3). When S12 ends, the control device 24 ends the process of FIG. 8. As described above, even after S10 is determined to be YES, the first remaining battery capacity and the second remaining battery capacity may be slightly different from each other. For example, when the first parallel circuit is formed in a situation where the second remaining battery capacity is slightly smaller than the first remaining battery capacity, a circulating current may flow from the first battery unit 20A to the second battery unit 20B without passing through the electric motor 12. Under such circumstances, arcing may occur in the third relay RL3 and the fourth relay RL4 when the third relay RL3 and the fourth relay RL4 are opened. In this regard, in the present embodiment, current is prohibited from flowing from the negative electrode power supply line 32 toward the series line 34 by the second diode D2. This suppresses the circulation current from flowing. Therefore, arcing of the third relay RL3 and the fourth relay RL4 is suppressed.

In addition, in S20, the control device 24 determines whether or not the first remaining battery capacity exceeds the second remaining battery capacity. When the first remaining battery capacity exceeds the second remaining battery capacity (YES in S20), the control device 24 proceeds to S22. On the other hand, when the first remaining battery capacity does not exceed the second remaining battery capacity (NO in S20), the control device 24 proceeds to S30.

In S22, the control device 24 controls the connection circuit 22 to form a second regenerative circuit (see FIG. 5). As a result, regenerative power is supplied only to the second battery unit 20B. As a result, the residual capacity difference between the first battery residual capacity and the second battery residual capacity decreases.

In S24, the control device 24 determines whether or not the first remaining battery capacity and the second remaining battery capacity are the same. When the first remaining battery capacity and the second remaining battery capacity are the same (YES in S24), the control device 24 proceeds to S12. On the other hand, when the first remaining battery capacity and the second remaining battery capacity are not the same (NO in S24), the control device 24 returns to S20. Although not shown, the control device 24 executes S24 process when a predetermined period of time elapses after S22 or S30 ends.

In addition, in S30, the control device 24 controls the connection circuit 22 to form a first regenerative circuit (see FIG. 4). As a result, regenerative power is supplied only to the first battery unit 20A. As a result, the capacity difference between the first battery remaining capacity and the second battery remaining capacity decreases. When S30 ends, the control device 24 proceeds to S24.

As described above, in the switching process of FIG. 8, the control device 24 is preferentially connected to the electric motor 12 from the battery unit having the smallest remaining capacity when switching from the motor operation to the regenerative operation is performed. Note that there may be a slight residual capacitance difference between the plurality of battery units 20 after it is determined as YES in S10 or YES in S24. In a case where the first parallel circuit is formed by the connection circuit 22, even if the remaining capacity of the battery unit having a large remaining capacity reaches the full charge capacity, the supply of the regenerative power to the battery unit having a small remaining capacity is continued. Therefore, the remaining capacity of the battery unit having a small remaining capacity also approaches the full charge capacity. Accordingly, the residual capacity difference between the plurality of battery units 20 can be further reduced.

As described above, the power supply device 10 includes the plurality of battery units 20, the connection circuit 22, and the control device 24 that controls the operation of the connection circuit 22. The connection circuit 22 selectively forms a first series circuit (an example of a “series circuit”) that connects the plurality of battery units 20 in series to the electric motor 12 (an example of an “electric load”), and a first parallel circuit (an example of a “parallel circuit”) that connects the plurality of battery units 20 in parallel to the electric motor 12. The control device 24 can individually connect and disconnect each of the plurality of battery units 20 to the electric motor 12 in the first parallel circuit. The control device 24 is configured to control the connection circuit 22 to form a first parallel circuit when regenerative electric power is supplied from the electric motor 12 to the plurality of battery units 20.

According to the above configuration, when regenerative power is supplied from the electric motor 12 to the plurality of battery units 20, the control device 24 controls the connection circuit 22 to form the first parallel circuit. When the plurality of battery units 20 are connected in parallel, each of the plurality of battery units 20 can be individually connected to and disconnected from the electric motor 12. Thus, when regenerative electric power is supplied from the electric motor 12, it is possible to charge the battery unit having the smallest remaining capacity while prohibiting charging of the battery unit having a large remaining capacity. This makes it possible to reduce the residual capacity difference between the plurality of battery units 20.

Further, as shown in FIG. 8, when forming the first parallel circuit by controlling the connection circuit 22, the control device 24 preferentially connects the battery unit having the smallest remaining capacity among the plurality of battery units 20 to the electric motor 12.

According to the above configuration, the regenerative electric power supplied from the electric motor 12 is preferentially supplied to the battery unit having a small remaining capacity. Therefore, the residual capacity difference between the plurality of battery units 20 can be reduced at an early stage.

Further, as shown in FIG. 2, when power is supplied from the plurality of battery units 20 to the electric motor 12, the control device 24 controls the connection circuit 22 to form a first series circuit.

According to the above-described configuration, it is possible to supply high-voltage power from the plurality of battery units 20 to the electric motor 12 as compared with a configuration in which the first parallel circuit is formed by the connection circuit 22.

Further, as shown in FIG. 1, the connection circuit 22 is provided with a second diode D2 (an exemplary “circulating current suppressing device”) that suppresses a circulating current from flowing between the plurality of battery units while the connection circuit 22 forms the first parallel circuit.

When a circulating current flows between the plurality of battery units 20, an abnormality may occur in the connection circuit 22. According to the above configuration, it is possible to suppress occurrence of abnormality in the connection circuit 22.

As illustrated in FIG. 1, electrified vehicle 2 includes a power supply device 10, an electric motor 12, and a charging port 14. The charging port 14 is configured to be detachable from an external charging device and is connected to a plurality of battery units 20 via a connection circuit 22.

In electrified vehicle 2, discharging and charging of the battery unit are repeated frequently in accordance with acceleration and deceleration of electrified vehicle 2. Therefore, by adopting the power supply device 10 according to the present technique in electrified vehicle 2, the residual capacities of the plurality of battery units 20 are eliminated at a high frequency while electrified vehicle 2 is running normally. Thus, before the plurality of battery units 20 are charged by the external charging device, the residual capacity difference between the plurality of battery units 20 can be eliminated or reduced in advance. Therefore, it is possible to easily charge the plurality of battery units 20 to a fully charged state without requiring complicated control when charging by an external charging device.

In addition, in electrified vehicle 2, when the remaining capacity of one of the plurality of battery units 20 becomes zero, the remaining capacity of the other of the battery units 20 may not be zero. Even in this case, the supply of electric power from the plurality of battery units 20 to the electric motor 12 may be stopped. According to the above configuration, since the residual capacity difference between the plurality of battery units 20 is relatively small, when the remaining capacity of one of the battery units 20 becomes zero, the remaining capacity of the other of the battery units 20 is close to zero. Therefore, the plurality of battery units 20 can be effectively used.

Although the specific examples disclosed by the present disclosure have been described in detail above, these are merely examples and do not limit the scope of claims. The techniques described in the claims include various modifications and alternations of the specific example illustrated above. Modifications of the above-described embodiment are listed below.

### First Modification

The number of the plurality of battery units is not limited to two, and may be three or more.

### Second Modification

S30 can be omitted from S10, S20 of FIG. 8.

### Third Modification

When power is supplied from the plurality of battery units 20 to the electric motor 12, the control device 24 may control the connection circuit 22 to form a first parallel circuit.

### Fourth Modification

The connection circuit 22 may not include the first diode D1 and the second diode D2.

### Fifth Modification

The connection circuit 22 may include a switching mechanism or the like for switching the electric connection between the respective lines in place of the first relay RL1 and the seventh relay RL7.

The technical elements described in this specification or in the drawings may be used alone or in various combinations, and are not limited to the combinations described in the claims at the time of filing. Further, the technology illustrated in the present specification or the drawings can achieve a plurality of objects at the same time, and has technical usefulness by achieving one of the objects.

What is claimed is:

1. A power supply device, comprising:
a plurality of battery units;
a connection circuit that selectively forms a series circuit that connects the battery units in series to an electrical load or a parallel circuit that connects the battery units in parallel to the electrical load; and
a control device that controls an operation of the connection circuit, wherein
the control device is able to individually connect and disconnect each of the battery units to and from the electrical load in the parallel circuit, and
the control device is configured to control the connection circuit to form the parallel circuit when a regenerative power is supplied from the electrical load to the battery units.

2. The power supply device according to claim 1, wherein when controlling the connection circuit to form the parallel circuit, the control device connects, to the electrical load, the battery units preferentially from the battery unit with a lowest remaining capacity.

3. The power supply device according to claim 2, wherein when supplying a power from the battery units to the electrical load, the control device controls the connection circuit to form the series circuit.

4. The power supply device according to claim 1, wherein in a state in which the connection circuit forms the parallel circuit, the connection circuit is provided with a circulating current suppressing mechanism that suppresses a circulating current from flowing among the battery units.

5. An electrified vehicle, comprising:
the power supply device according to claim 1;
an electric motor that drives wheels of the electrified vehicle as the electric load; and
a charging port that is configured such that an external charging device is attachable to and detachable from the charging port, and is connected to the battery units via the connection circuit.
